(19) United States
(12) Patent Application Publication
(10) Pub. No.: US 2003/0127253 A1
(43) Pub. Date: Jul. 10, 2003

(54) Electronic tournament fishing organizer

(76) Inventor: Donald R. Heyn, Irving, TX (US)

Correspondence Address: RANDAL D. HOMBURG, P.O. BOX 10470, MIDWEST CITY, OK, 73140-1470, US

(21) Appl. No.: 10/037,889

(22) Filed: Jan. 7, 2002

(51) Int. Cl. G01G 19/56

(52) U.S. Cl. 177/148

(57) ABSTRACT

The invention is an electronic device and method of using the device, intended for primary use in fishing tournaments, where multiple fish are caught and the winning fisherman determined by the combined live weight of the allotted number of fish, the device electronically weighing, assigning and identification color, and displaying up to six weighted entries and their total weight at the same time. The device includes an automatic power saver which reduces the power to the device when the device is laid down and has a sound producing element to indicate the weights and color assignments of the weighed entries during the weighing and storing process.

### CROSS REFERENCE TO RELATED APPLICATIONS

None

### I. BACKGROUND OF THE INVENTION

1. Field of Invention

The invention is an electronic device intended for primary use in fishing tournaments, where multiple fish are caught and the winning fisherman determined by the combined live weight of the allotted number of fish, the device electronically weighing, assigning and identification color, and displaying up to five weighted entries and their total weight at the same time. The device includes an automatic power saver which reduces the power to the device when the device is laid down and has a sound producing element to indicate the weights and color assignments of the weighed entries during the weighing and storing process.

2. Description of Prior Art

The following United States patents were discovered and are disclosed within this application for utility patent. All relate to fishing scales and weighing devices.

Most closely related to the current invention is U.S. Pat. No. 5,545,855 to Stanfield, which includes an electronic scale for use in fishing tournaments. This invention can weigh, sort and scroll through stored color tagged fish, but it lacks the ability to display a plurality of catches on the same screen and contemporaneously display the combined weight of the entire catch. This device also lacks the audible signaling of the data entry stored in the device, such means included in the current invention. It has an audible alarm indicating false data, but not an audible means which verbally announces the data being recorded. Other hand-held weighing devices are disclosed in U.S. Pat. Nos. 5,031,710 to Parker and 4,936,399 to Christman.

U.S. Pat. No. 5,854,447 to Greenwood is a basket weighing device which displays the weight, length and girth of a fish contained in the basket. In U.S. Pat. No. 6,043,438 to Helberg, a hand-held scale is disclosed which has a pivotal display screen movable for optimal viewing by the person using the device. A fish is disclosed in the drawings as the object being weighed. A manual recording peg board with peg markers is disclosed in U.S. Pat. No. 5,979,752 to

### II. SUMMARY OF THE INVENTION

The primary objective of the invention is to provide a tournament fish scale and data storage device for persons involved in tournament fishing which provides a multiple row fish display indicating a weight, running weight total, a fish color assignment, an audible registry, a simple tracking and deletion system and an easy fish replacement mechanism, reducing the time it takes to keep records of the daily catch of fish.

A second objective is to make the device with a double delete key to reduce the accidental and unintentional deletion of recorded data.

### III. DESCRIPTION OF THE DRAWINGS

The following drawings are submitted with this utility patent application.

FIG. 1 is a front view of the device showing the display panel and the operational buttons.

FIG. 2 is a flow chart of the method of using the device.

FIG. 3 is a block configuration of FIG. 1.

FIGS. 4a and 4b are detailed drawings of the electrical schematics of the invention.

FIG. 5 is a color coded hook tag.

### IV. DESCRIPTION OF THE PREFERRED EMBODIMENT

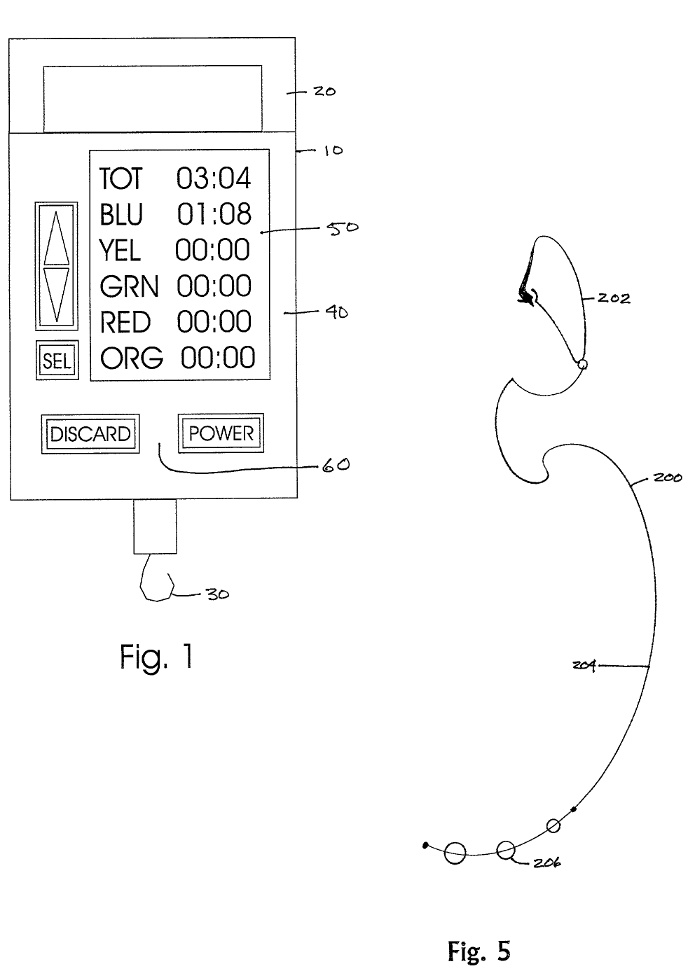

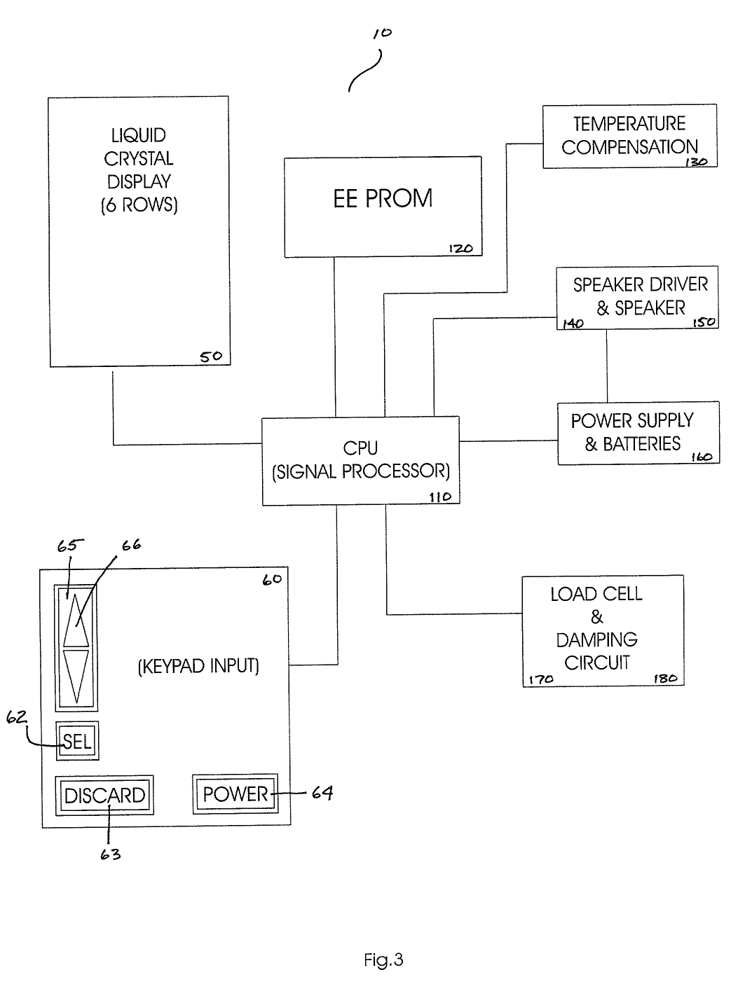

The invention, as shown in FIGS. 1 and 3 of the drawings, is a device for weighing and recording fish used primarily in tournament fishing, the device including essentially a control box 10 having a handle 20, a weigh hook 30, a water-proof encasement 40, a six row liquid crystal display 50, a keypad input 60, and internal electronic components 100 including a CPU signal processor 110, an EE PROM 120, a temperature compensation cell 130, a speaker driver 140 and speaker 150, a power supply 160, a load cell 170, a damping circuit 180 and a plurality of color coded hook tags 200.

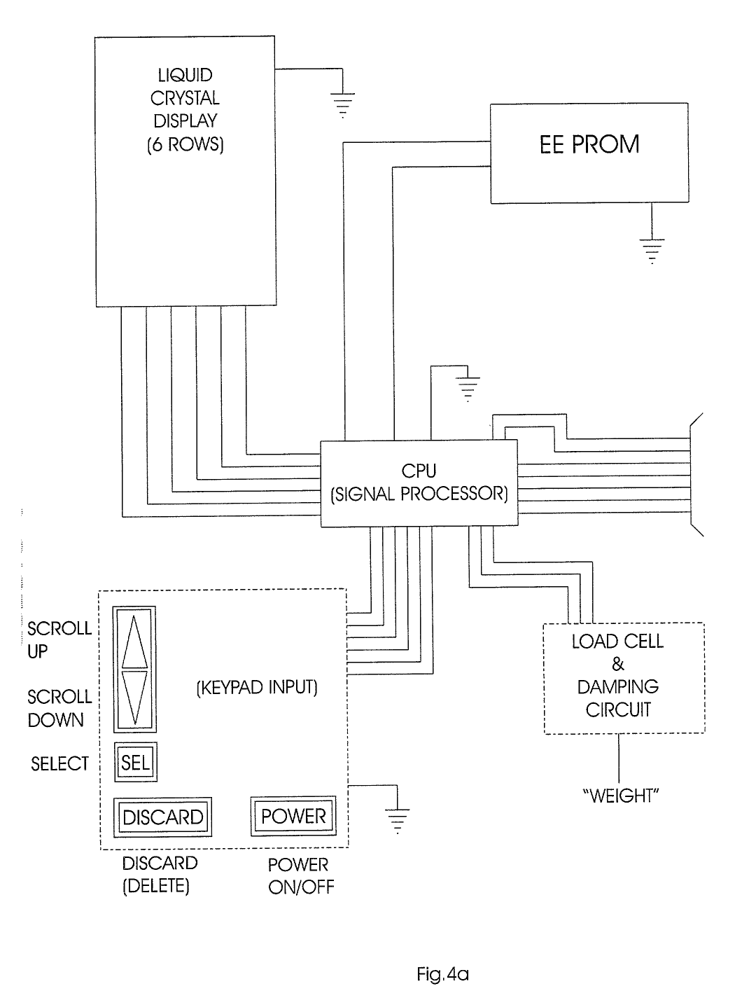

More specifically, as shown in FIGS. 4a and 4b of the drawings, the internal electronic components 100 comprise the CPU signal processor 110, controlling and directing the other electronic elements, to which is attached the six row liquid crystal display 50, which visually displays an assigned color and weight of each recorded fish entry, the EE PROM 120, responsible for the program functions, the keypad input 60, having a select button 62, a discard button 63, a power button 64 and a scroll key 65 having an up and a down rocker button 66, the load cell 170 and damping circuits 180 connected to the suspended weigh hook 30, which perform the weigh tasks, the temperature compensation cell 130, which controls the environmental thermal deviations insuring accuracy of the weigh process to the nearest ounce, the speaker 150 and speaker driver 140, which activates pre-programmed audible prompts during the weigh process, and the power supply 160, which preferably, is included as dry cell batteries.

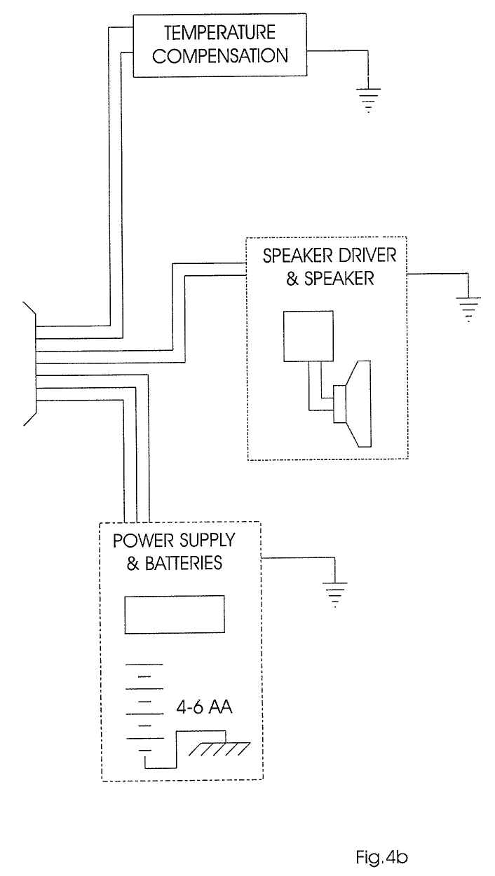

The color coded hook tags 200, as shown in FIG. 5 of the drawings, comprise a cord 204 having a hooked latch portion 202 and a plurality of colored beads 206. The hooked latch portion 202 is attached to the fish, preferably through the mouth of the fish, with the cord 204 and colored beads 206 hanging from the mouth of the fish for identification of the fish by color and relating that fish to the recorded entry on the liquid crystal display 50. A color coded hook tag 200 should be provided for each color indicated on the liquid crystal display 50.

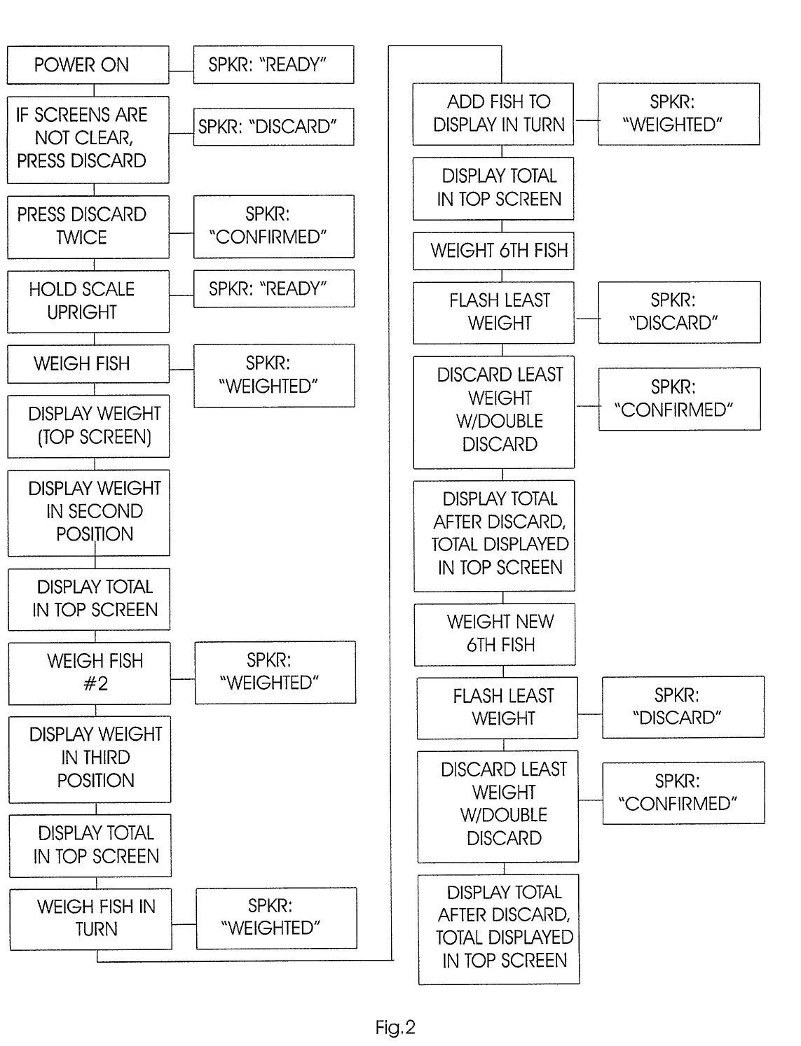

Operation of the device, as shown in FIG. 2 of the drawings, commences with the depression of the power switch 64, which initiates the power supply 160 to the device and causes the word “ready” to emanate from the speaker 150. If the six rows on the liquid display crystal are not clear, the discard button 63 is depressed, which causes the word “discard” to sound from the speaker 150. The discard button 63 is then depressed twice, which clears the liquid crystal display 50 and the word “confirmed” is emitted from the speaker 150.

The device is held in a upright position by the handle 20. The word “ready” is sounded again. The fishing is then begun. After the first fish is caught, the fish is applied to the weigh hook 30 until the word “weighted” is heard. The weight of the fish is recorded in the top row of the liquid crystal display 50, which is designated as the “total” row, and also recorded on the second line. A color coded hook tag 200 is applied to the fish, which is then deposited in a live well for keeping. A second fish is caught, placed on the weigh hook 30 and weighed, until the word “weighted” again sounds. The display weight is then shown on the liquid crystal display 50 on the third line and the first line is adjusted for total weight of the second and third line combined. That fish is then deposited in the live well after applying a corresponding color coded hook tag 200. This process is repeated until a sixth fish is caught, each time displaying the total cumulative weight on the first row. At that time, the fish is placed on the weigh hook 30 until the word “weighted” is heard. At that time, the least weighted row on the liquid crystal display 50 will flash and the word “discard” will be heard. To delete the fifth lowest weight, the discard button 63 is pressed twice, after which the word “confirmed” is heard. The weight total is displayed after the deletion of the fifth lowest weight. This is repeated until the fishing is concluded. The five fish with the highest weight are kept in the live well and their weight, by fish and by total is displayed and stored in the device. The color coded hook tag 200 of the lower weight fish to be released is removed prior to release and attached to the fish replacing that lower weight fish and then placed in the live well for keeping.

In the event that a fish expires during the tournament (where the tournaments require all fish entries to be alive at the conclusion of the event), the user may depress the select key 62, scroll to the entry coinciding with the expired fish using the rocker button 66 on the scroll key 65, press the delete button 63 twice, and remove the entry. The speaker 150 will sound with the words “select”, “discard” and “confirmed” during this deletion of the expired fish. At the conclusion of the fishing event, the power switch 64 is depressed and the device is stored away until its next use.

In a preferred embodiment, the device may have a means of temporarily shutting off the active power to the device (not shown), when the device is laid down for a period of time, the device storing the data in the device until intentionally clearing the data from the device.

While the invention has been particularly shown and described with reference to a preferred embodiment thereof, it will be understood by those skilled in the art that changes in form and detail may be made therein without departing from the spirit and scope of the invention.

What is claimed is:

1. A device for weighing and recording fish used primarily in tournament fishing, the device comprising essentially:
a control box having a handle, a weigh hook, a water-proof encasement, a six row liquid crystal display, a keypad input, and internal electronic components, including a CPU signal processor, an EE PROM, a temperature compensation cell, a speaker driver and speaker, a power supply, a load cell connected to the weigh hook, a damping circuit and a plurality of color coded hook tags.

2. The device, as disclosed in claim 1, the internal electronic components further comprising:
the CPU signal processor, controlling and directing the other electronic elements, to which is attached the six row liquid crystal display, which visually displays an assigned color and weight of each recorded fish entry, the EE PROM, responsible for the program functions, the keypad input, having a select button, a discard button, a power button and a scroll key having an up and a down rocker button, the load cell and damping circuits connected to the suspended weigh hook, which perform the weigh tasks, the temperature compensation cell, which controls the environmental thermal deviations insuring accuracy of the weigh process to the nearest ounce, the speaker and speaker driver, which activates pre-programmed audible prompts during the weigh process, and the power supply, which preferably, is included as dry cell batteries.

3. The device, as disclosed in claim 1, the color coded hook tags further comprising:
a cord having a hooked latch portion and a plurality of colored beads, the hooked latch portion attached to the fish for identification of the fish by color and relating that fish to the recorded entry on the liquid crystal display, a color coded hook tag provided for each color indicated on the liquid crystal display.

4. A method for using a device for weighing and recording fish used primarily in tournament fishing, the device comprising a control box having a handle, a weigh hook, a water-proof encasement, a six row liquid crystal display, a keypad input having a select button, a discard button, a power button and a scroll key having an up and a down rocker button, and internal electronic components, including a CPU signal processor, an EE PROM, a temperature compensation cell, a speaker driver and speaker, a power supply, a load cell connected to the weigh hook, a damping circuit and a plurality of color coded hook tags, such method comprising the steps of:
a. engaging the power to the device until the word “ready” is sounded;
b. clearing the six row liquid crystal display by pressing the discard button until the word “discard” is sounded;
c. pressing the discard button twice until the word “confirmed” is sounded;
d. holding the scale in a upright position until the word “ready” is sounded;
e. placing a first fish on the weigh hook until the word “weighted” is sounded and the weight of the first fish is displayed on a second line of the liquid crystal display with the total weight displayed on a first line of the liquid crystal display, and placing a color coded hook tag on the first fish corresponding to the color of the line at which the first fish appears;
f. placing a second fish on the weigh hook until the word “weighted” is sounded and the weight of the second fish is displayed on the second line or on a third line of the liquid crystal display, with the total weight displayed on a first line of the liquid crystal display, and placing a color coded hook tag on the second fish corresponding to the color of the line at which the second fish appears;
g. repeating the weigh process until five fish have been weighed and five color coded hook tags have been placed on the five fish caught;
h. after catching a sixth fish, placing the sixth fish on the weigh hook until the word weighted appears;
i. if a line on the liquid crystal display is flashing, indicating the sixth fish having a higher weight than the lowest weight of the previous five fish, and the word “discard” is sounded, pressing the discard button twice, until the word “confirmed is sounded;
j. removing the color coded hook tag from the fish from the first five caught corresponding to the deleted entry, releasing that fish and placing the color coded hook tag on the fish replacing that lower weight fish; and
k. repeating the above process until the conclusion of the tournament fishing process is concluded, the device displaying the five highest weight fish caught during the tournament and displaying the total weight on the first line of the liquid crystal display.
